(19) United States
(12) Patent Application Publication
(10) Pub. No.: US 2016/0062719 A1
(43) Pub. Date: Mar. 3, 2016

(54) Systems and Methods for Automatic Content Display

(71) Applicant: Synterna Technologies, Inc., Flower Mound, TX (US)

(72) Inventors: Mariano Martin Romano, The Colony, TX (US); Jeremy Byron Haltom, Sachse, TX (US)

(21) Appl. No.: 14/844,514

(22) Filed: Sep. 3, 2015

Related U.S. Application Data
(60) Provisional application No. 62/045,364, filed on Sep. 3, 2014.

(51) Int. Cl. G06F 3/14; H04W 76/06; H04W 76/02; H04W 4/00; H04W 4/02

(52) U.S. Cl. CPC G06F 3/14; H04W 4/008; H04W 4/023; H04W 76/02; H04W 76/06

(57) ABSTRACT

Systems and methods for dynamically associating display and content devices in accordance with embodiments of the invention are disclosed. In one embodiment, a content display system includes a content display controller including a processor, a memory, a network interface, and a proximity sensor, a display device connected to the content display controller, and a content device including a processor, a memory, and a network interface, wherein the content display controller determines when the content device is within range using the proximity sensor, initiates a connection with the content device, obtains data from the content device using its network interface, and displays the obtained data using the display device and wherein the content device presents at least one piece of content data for display, determines when the content device is connected to a content display controller, and transmits the at least one piece of content data to the content display controller.

### CROSS-REFERENCE TO RELATED APPLICATIONS

The current application claims priority to U.S. Provisional Patent Application Ser. No. 62/045,364, filed Sep. 3, 2014, the disclosure of which is hereby incorporated by reference in its entirety.

### FIELD OF THE INVENTION

The present invention relates to pairing devices and more specifically to dynamically pairing display devices to content devices.

### BACKGROUND

Bluetooth Low Energy is a wireless network technology developed by the Bluetooth Special Interest Group of Kirkland, Wash. Bluetooth Low Energy is designed to facilitate wireless communication between a variety of devices using physically small and low-power transmitters, usually operating in the 2.4 GHz ISM band.

A data network is a set of connections that allow communications between varieties of devices connected to the network. In many networks, the connections may be physical wires and/or wireless links. Furthermore, a variety of networking hardware can be incorporated into the data network in order to facilitate communication between the various devices and/or between networks along.

### SUMMARY OF THE INVENTION

Systems and methods for dynamically associating display and content devices in accordance with embodiments of the invention are disclosed. In one embodiment, a content display system includes a content display controller including a processor, a memory connected to the processor, a network interface connected to the processor and the memory, and a proximity sensor, a display device connected to the content display controller, and a content device including a processor, a memory connected to the processor, and a network interface connected to the processor and the memory, wherein the content display controller determines when the content device is within range using the proximity sensor, initiates a connection with the content device, obtains data from the content device using the network interface in the content display controller, and displays the obtained data using the display device and wherein the content device presents at least one piece of content data for display, determines when the content device is connected to a content display controller, and transmits the at least one piece of content data to the content display controller using the network interface in the content device.

In another embodiment of the invention, the content display system further includes a network controller connected to the network and the network controller controls data transmitted via the network.

In an additional embodiment of the invention, the content display controller initiates the connection to the content device by requesting a connection with the content device from the network controller.

In yet another additional embodiment of the invention, the network controller obtains content display controller data describing the content display controller, obtains content device data describing the content device, and generates authorization data including the content display controller data and the content device data.

In still another additional embodiment of the invention, the display controller data includes a media access control address identifying the content display controller and the content device data includes a media access control address identifying the content device.

In yet still another additional embodiment of the invention, the network controller creates a one-way connection between the content display controller and the content device so that content provided by the content device can be transmitted to the content display controller.

In yet another embodiment of the invention, the network controller creates a virtual local area network including the content display controller and the content device.

In still another embodiment of the invention, the proximity sensor includes a Bluetooth Low Energy device.

In yet still another embodiment of the invention, the content display controller further determines when the content device is no longer within range using the proximity sensor and initiates a disconnection from the content device.

In yet another additional embodiment of the invention, the content display controller further determines display device state data when the content device is in range, where the display device state data describes an active input of the display device, switches the display device to a second input separate from the active input, where the second input is associated with the content display controller, and when the content device is no longer within range, switches the display device to the active input.

Still another embodiment of the invention includes a method for displaying content including determining when a content device is within range using a content display controller, wherein the content display controller includes a processor, a memory connected to the processor, a network interface connected to the processor and the memory, and a proximity sensor and the content device includes a processor, a memory connected to the processor, and a network interface connected to the processor and the memory, initiating a connection with the content device using the content display controller, presenting at least one piece of content data for display using the content device, determining when the content device is connected to a content display controller using the content device, transmitting the at least one piece of content data to the content display controller using the network interface in the content device, obtaining data from the content device using the network interface in the content display controller, and displaying the obtained data using a display device connected to the content display controller.

In yet another additional embodiment of the invention, the content display system further includes a network controller connected to the network and the network controller controls data transmitted via the network.

In still another additional embodiment of the invention, the content display controller initiates the connection to the content device by requesting a connection with the content device from the network controller.

In yet still another additional embodiment of the invention, the method further includes obtaining content display controller data describing the content display controller using the network controller, obtaining content device data describing the content device using the network controller, and generating authorization data including the content display controller data and the content device data using the network controller.

In yet another embodiment of the invention, the display controller data includes a media access control address identifying the content display controller and the content device data includes a media access control address identifying the content device.

In still another embodiment of the invention, the method further includes creating a one-way connection between the content display controller and the content device so that content provided by the content device can be transmitted to the content display controller using the network controller.

In yet still another embodiment of the invention, the method further include creating a virtual local area network including the content display controller and the content device using the network controller.

In yet another additional embodiment of the invention, the proximity sensor includes a Bluetooth Low Energy device.

In still another additional embodiment of the invention, the method further includes determining when the content device is no longer within range using the content display controller and initiating a disconnection from the content device using the content display controller.

In yet still another additional embodiment of the invention, the method further includes determining display device state data when the content device is in range using the content display controller, where the display device state data describes an active input of the display device, switching the display device to a second input separate from the active input using the content display controller, where the second input is associated with the content display controller, and when the content device is no longer within range, switching the display device to the active input using the content display controller.

### BRIEF DESCRIPTION OF THE DRAWINGS

FIG. 1 is a conceptual illustration of a content display system in accordance with an embodiment of the invention.

FIG. 2 is a conceptual illustration of a content display controller in accordance with an embodiment of the invention.

FIG. 3 is a flow chart illustrating a process for displaying content in accordance with an embodiment of the invention.

FIG. 4 is a flow chart illustrating a process for disconnecting content devices in accordance with an embodiment of the invention.

FIGS. 5A-B are flow charts illustrating processes for configuring a network in accordance with an embodiment of the invention.

FIG. 6 is a flow chart illustrating a process for configuring a network for one-way communication in accordance with an embodiment of the invention.

FIGS. 7A and 7B are flow charts illustrating processes for detecting a display device in accordance with embodiments of the invention.

FIG. 7C is a flow chart illustrating a process for configuring a network to facilitate communication between a content device and a display device in accordance with an embodiment of the invention.

### DETAILED DESCRIPTION

Turning now to the drawings, systems and methods for dynamically associating display and content devices in accordance with embodiments of the invention are disclosed. In many environments, it is desirable to display content on a device on a larger format display for easier viewing. For example, many hospitals include televisions in patient rooms. In these environments, the doctors can have various materials, such as patient charts and educational materials, on personal devices that they wish to share with the patients. By way of a second example, professors commonly display information on a projector during classes while students take notes using their own personal devices. Content display systems in accordance with embodiments of the invention allow content devices to dynamically connect to display devices that are within a particular range and present content via the display device. Content devices can provide a user interface for selecting, viewing, and interacting with any of a variety of content as appropriate to the requirements of specific applications of embodiments of the invention. In the doctor example, the doctor's content device can automatically connect to the display in the patient's room and display the patient's records and test results to aid in the discussion between doctor and patient. With respect to the classroom example, the professor can select one or more of the student's content devices and automatically display content present on the student's devices on the classroom display, such as for sharing answers to questions posed in class and the results of group collaborations.

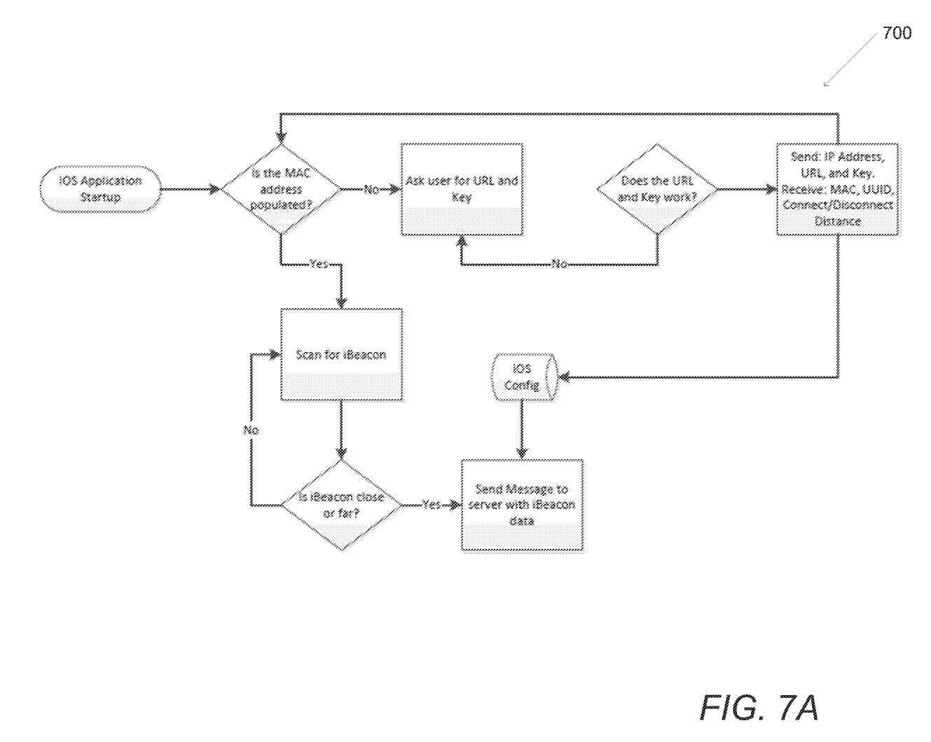

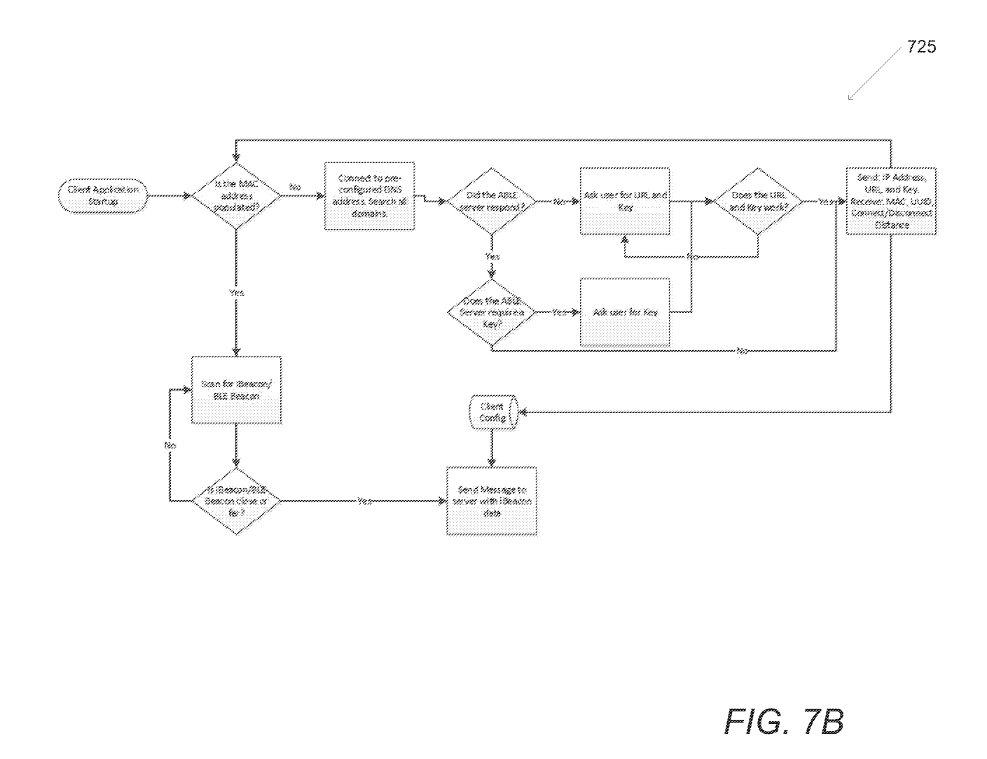

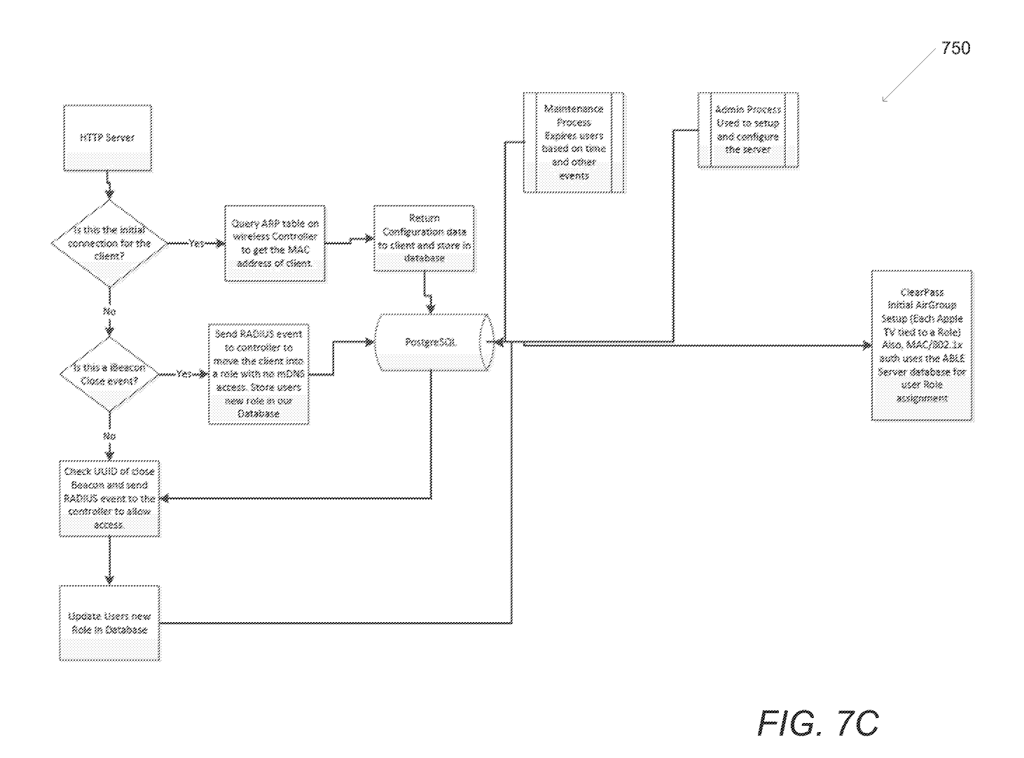

Content display systems can include content display controllers connected to display devices that aid in the identification of content devices within range of the display device. A flow chart conceptually illustrating a process for identifying when a content display controller is within range of a content device in accordance with an embodiment of the invention is shown in FIG. 7A. A flow chart conceptually illustrating an alternative process for identifying when a content display controller is within range of a content device in accordance with an embodiment of the invention is shown in FIG. 7B. The content devices and/or content display controllers can cause a network to be configured and/or created in order to allow communication between the content device and the content display controller. A flow chart conceptually illustrating a process for configuring a network to allow communication between a content display controller and a content device in accordance with an embodiment of the invention is shown in FIG. 7C.

In many embodiments, the content display controller and/or the content device identify when the content device is out of range of the content display controller (for example, when the doctor leaves the patient's room) and configure the network in order to prevent the display of content on the content device on the display device associated with the content display controller. In several embodiments, content devices can be dynamically associated and disassociated with content display controllers based on instructions received from a master content device (e.g. a professor's computer in a classroom setting). In a variety of embodiments, the association of content devices and content display controllers includes configuring a display device to switch to a particular set of settings, i.e. switch to a particular input associated with displaying content. Likewise, the disassociation of a content device from a content display controller can include configuring a display device to switch to a second set of settings, i.e. to switch to a second input. For example, if a patient is watching television when their doctor enters the room, their display device can automatically switch to display the doctor's content, and as the doctor leaves the room the display automatically switches back to the television channel the patient was watching. Security measures can be also be taken in the association of devices and network configuration as appropriate to the requirements of specific applications of the invention.

### Content Display Systems

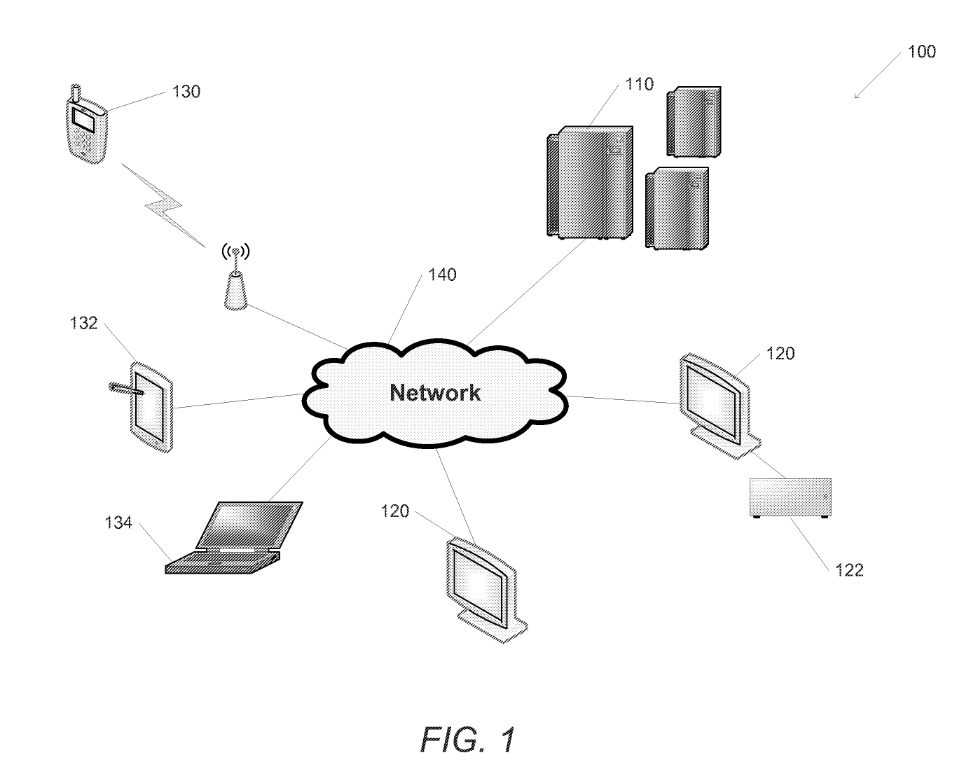

Content display systems in accordance with embodiments of the invention allow for the display of content present on a content device on a display device when the content device is proximate to the display device. Similarly, the display of content can be halted and/or prevented when the content device is no longer proximate to the display device. A conceptual diagram of a content display system in accordance with an embodiment of the invention is shown in FIG. 1. The content display system 100 includes a network controller 110, display devices 120 and content display controllers 122, and content devices such as, but not limited to, mobile devices 130, tablet devices 132, and personal computers 134 configured to communicate via a network 140. In a variety of embodiments, the network 140 is a local area network (LAN), although any network such as a wide area network and/or the Internet can be utilized as appropriate to the requirements of specific applications of embodiments of the invention.

In a number of embodiments, the network controller 110 is implemented utilizing any of a variety of hardware, such as, but not limited to, one or more server systems, databases, switches, routers, and any other systems utilized to provide and manage the network 140. In several embodiments, the network controller 110 provides the Aruba AirGroup service provided by Aruba Networks of Sunnyvale, Calif. However, it should be noted that any network configuration technology, such as the Bonjour service provided by Apple, Inc. of Cupertino, Calif., the zero-configuration networking methodology, the Simple Service Discovery Protocol (SSDP), the Universal Plug and Play (UPnP) protocol, and the creation of physical local area networks and/or virtual local area networks (VLANs) can be utilized as appropriate to the requirements of specific applications of the invention.

In many embodiments, the content display controller 122 is connected to one or more display devices 120. In a variety of embodiments, the content display controller 122 includes a proximity sensor that identifies when a content device is in range of the display device and/or when the content device has left the range of the display device. Any of a variety of proximity sensors, such as, but not limited to, an iBeacon system provided by Apple, Inc. and/or a Bluetooth Low Energy device utilizing a proximity sensing profile, can be utilized as appropriate to the requirements of specific applications of the invention. When a content device is proximate to a display device 120, the content display controller 122 and/or the content device can transmit instructions to the network controller 110 in order to create a network connection (or otherwise allow communication) between the content device and the content display controller 122. In a number of embodiments, the content device communicates directly with the display device 120 and/or with the display device 120 via the network 140. In several embodiments, the content display controller 112 manipulates the functionality of the display device 120, such as changing the active input on the display device 120, in response to the proximity of a content device. It should be noted, however, that any configuration of hardware, including those embodiments where the content display controller 122 is integrated into the display device 120 and/or those where the content display controller 122 is divided between two or more separate pieces of hardware, can be utilized as appropriate to the requirements of specific applications of the invention.

Although a specific architecture of a content display system in accordance with embodiments of the invention are discussed above and illustrated in FIG. 1, a variety of architectures, including content devices not specifically named and other techniques for dynamically facilitating communication between devices connected to a network, can be utilized in accordance with embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention.

### Content Display Controllers

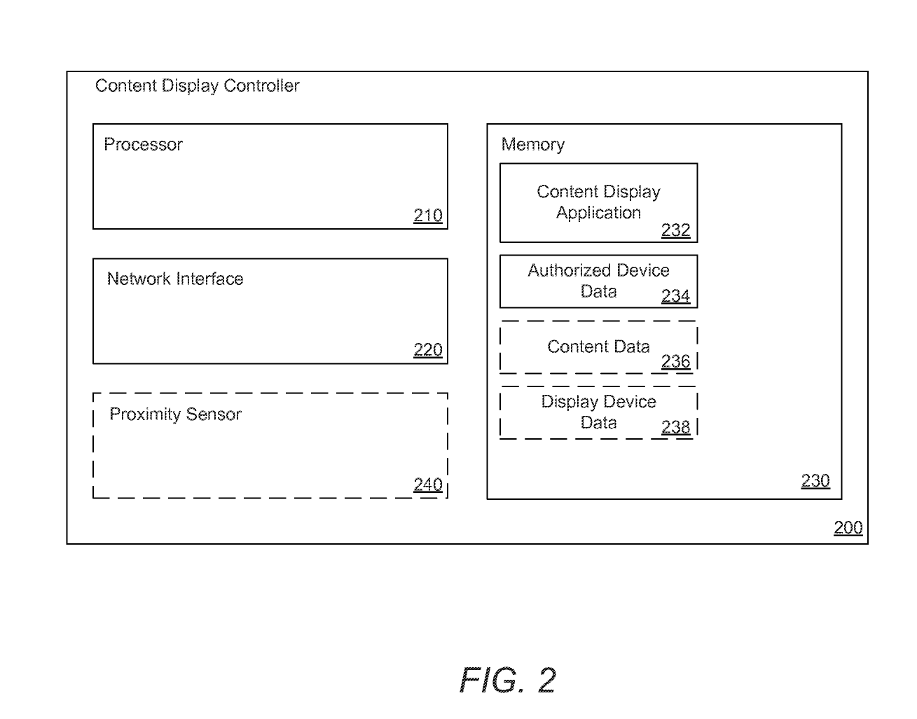

Content display controllers in accordance with embodiments of the invention can identify when a content device is proximate to a display device and aid in the communication of content data from the content device to the display device so that the content can be displayed using the display device. Additionally, content display controller can also identify when a content device is no longer proximate to the display device and prevent the display of the content via the display device when the content device has left the area. A conceptual illustration of a content display controller in accordance with an embodiment of the invention is shown in FIG. 2. The content display controller 200 includes a processor 210 in communication with memory 230. The content display controller 200 also includes a network interface 220 configured to send and receive data over a network connection. In a number of embodiments, the network interface 220 is in communication with the processor 210 and/or the memory 230. In several embodiments, the memory 230 is any form of storage configured to store a variety of data, including, but not limited to, a content display application 232, authorized device data 234, content data 236, and/or display device data 238. In many embodiments, the content display application 232, authorized device data 234, content data 236, and/or display device data 238 are stored using an external server system and received by the content display controller 200 using the network interface 220. In a variety of embodiments, the content display controller 200 also includes a proximity sensor 240 that determines when a device has entered an area monitored by the proximity sensor.

The processor 210 is directed by the content display application 232 to perform a variety of content display processes. These processes include determining when a content device is proximate to a display device and when the content device is no longer proximate to the display device. In several embodiments, content display processes include obtaining and/or determining authorized device data 234. Any of a variety of data that can be utilized to determine appropriate content devices to receive content data 236 from and/or to configure a network for facilitating communication between the content device and the content display controller 200 can be included in the authorized device data 234. This data includes time data, data identifying the content display controller 200 (such as a media access control (MAC) address and/or an internet protocol (IP) address (that can include one or more communication ports)), data identifying the content device and/or display device (such as a MAC address and/or IP address), distance data describing how close and/or far a content device should be before associating (and/or disassociating) the content device with the display device, location data describing the location of available content data, and any other data that can be utilized in content display processes as appropriate to the requirements of specific applications of the invention. In several embodiments, the time data includes the time at which the content device entered and/or left the proximity of the display device and/or time ranges that a particular content device can display data using the display device.

In many embodiments, the content data 236 is obtained from a content device and displayed via a display device. In a variety of embodiments, the content data 236 is transmitted directly to a display device by the content device. Any of a variety of techniques for transmitting and/or streaming content data 236 can be utilized as appropriate to the requirements of specific applications of the invention, such as, but not limited to, the AirPlay protocol provided by Apple, Inc., the Digital Living Network Alliance (DLNA) protocol, and the HTTP Live Streaming protocol.

In several embodiments, content display processes include identifying the state of a display device when a content device enters the proximity of the display device and obtaining display device data 238 describing the display device state. In a number of embodiments, content display processes further include setting the state of the display device based on the display device data 238 when the content device is no longer proximate to the display device. Additionally, content display processes can also include resetting (or otherwise purging) some or all of the authorized device data 234 and/or content data 236 when the content device is no longer proximate to the display device (via distance and/or as enforced using access time data) as appropriate to the requirements of specific applications of the invention. Similarly, content devices can also be purged of the connection data when they are no longer proximate to the display device.

Although a specific architecture for a content display controller in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory includes circuitry such as, but not limited to, memory cells constructed using transistors, that store instructions. Similarly, the processor can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Displaying Content

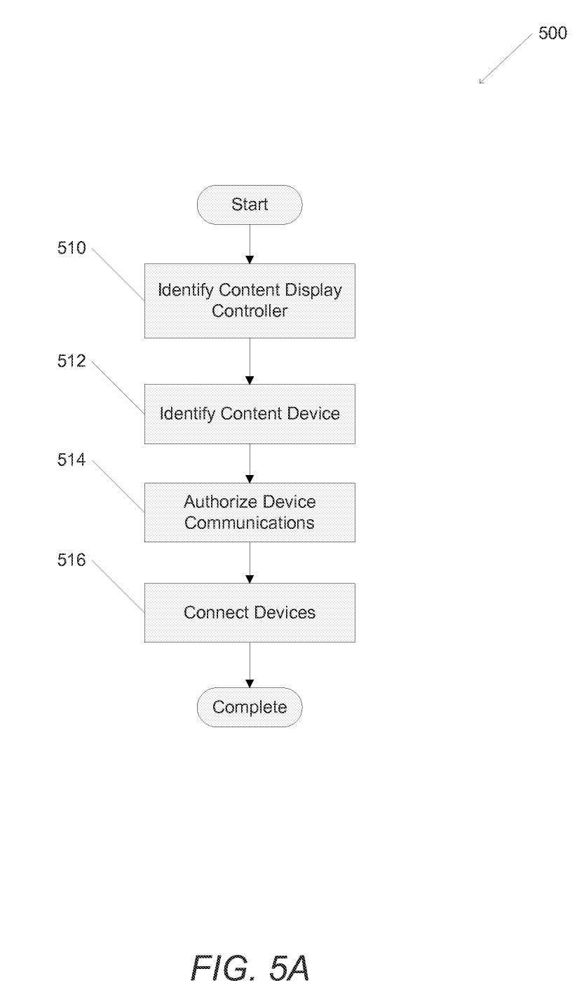

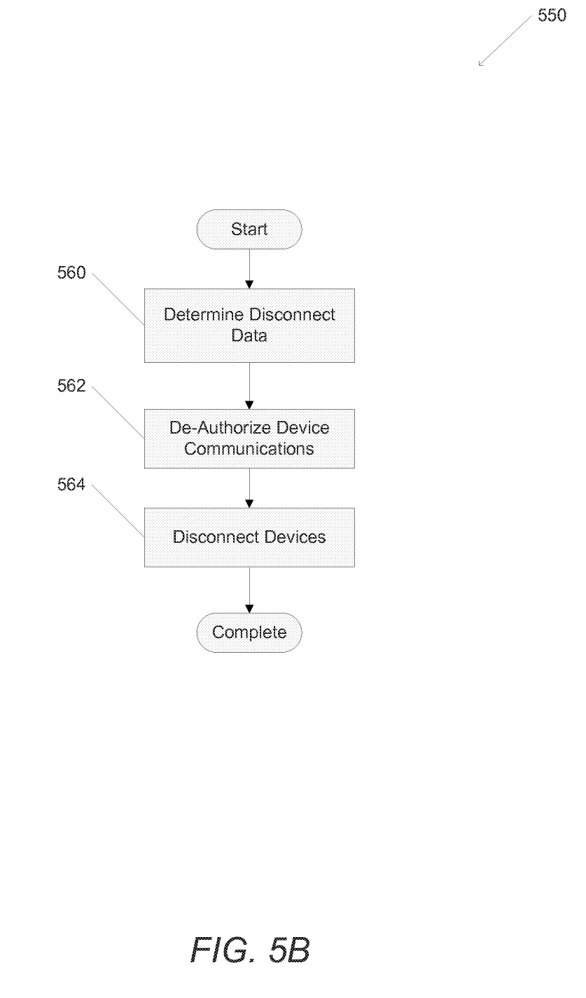

As described above, content display systems allow for the automatic display of content via one or more display devices from a content device based on the proximity (and/or time) of the content device to the display device. In a variety of embodiments, the display device (and its associated content display controller) and the content device are connected via a network connection and the proximity of the content device to the display device triggers the communication of content data from the content device to be display on the display device. The content display system can also facilitate the configuration of the network (such as by one or more access protocols and/or the creation of virtual networks) in order to facilitate the communication and display of content data. Techniques for configuring networks to facilitate the communication between the content devices and the content display systems that can be utilized in accordance with embodiments of the invention are described in more detail with respect to FIGS. 5A-B and 7A-C.

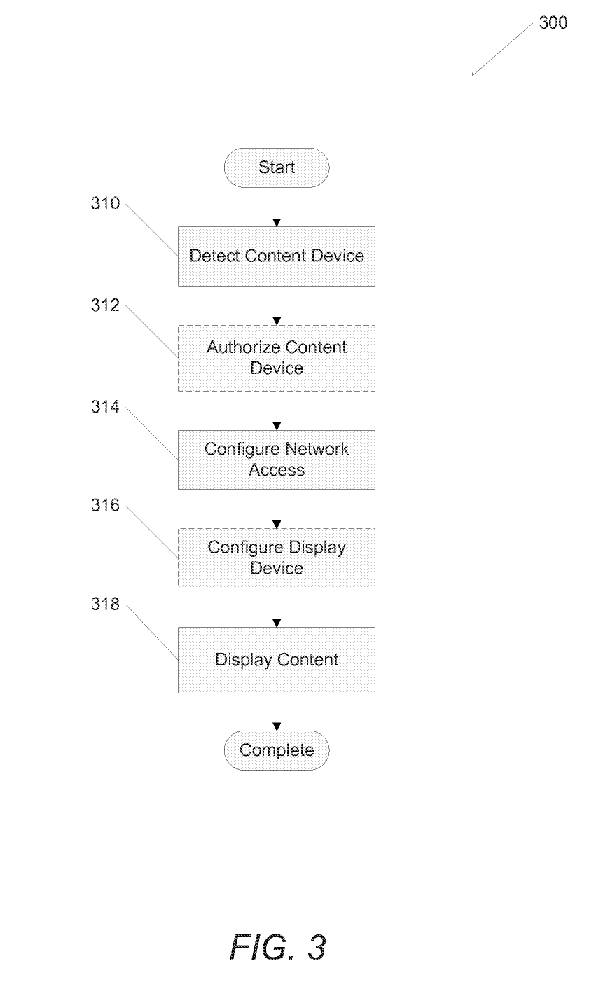

A process for displaying content in accordance with an embodiment of the invention is illustrated in FIG. 3. The process 300 includes detecting (310) a content device and, in many embodiments, authorizing (312) a content device. Network access is configured (314) and, in a number of embodiments, a display device is configured (316). Content is displayed (318).

Although specific processes for displaying content in accordance with embodiments of the invention are described above with respect to FIG. 3, any number of processes can be utilized as appropriate to the requirements of a specific application in accordance with embodiments of the invention.

### Disconnecting Content Devices

Once a content device leaves the proximity of a display device, it may no longer be desirable to display content from the content device on the display device. For example, if a doctor is displaying confidential patient data in a patient's room, it is imperative that the confidential data no longer be displayed when the doctor leaves the room so that unauthorized persons do not view the patient's data. Similarly, if a professor is teaching a class, once the class has ended and the professor has left the room it is not constructive to show the professor's notes to the next class taking place in the classroom. Additionally, if a content device becomes disconnected from the network for any reason (hardware failure, power off, etc. . . . ), the connection between the content device and the display device can be terminated, the network access reconfigured, and/or the devices flushed as appropriate to the requirements of specific applications of embodiments of the invention. Techniques that can be utilized in accordance with embodiments of the invention to configure networks are described in more detail with respect to FIGS. 5A-B and 7A-C.

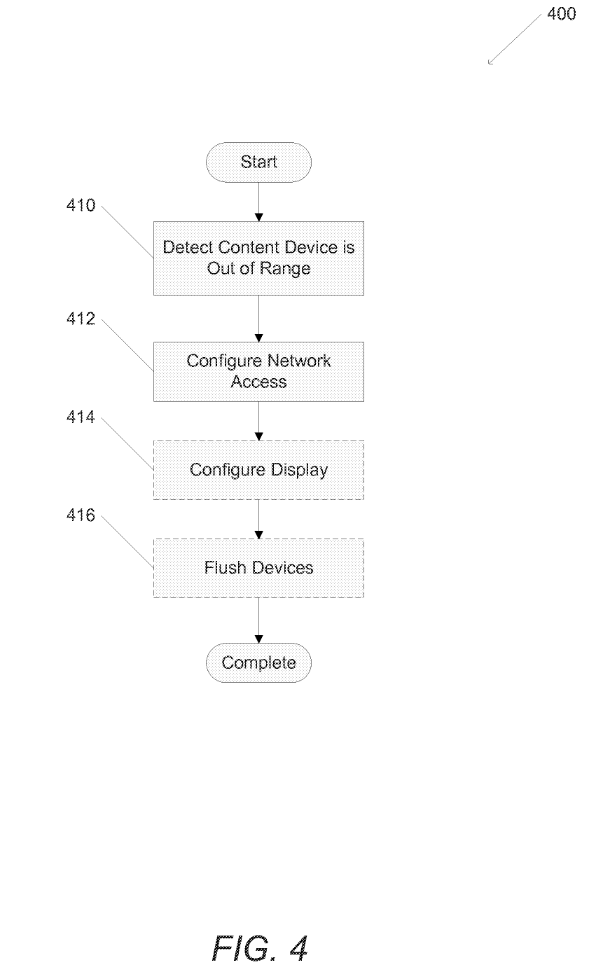

A process for disconnecting content devices in accordance with an embodiment of the invention is illustrated in FIG. 4. The process 400 includes detecting (410) when a content device is out of range and configuring (412) network access. In a variety of embodiments, a display is configured (414) and/or devices are flushed (416).

Specific processes for disconnecting content devices and display devices in accordance with embodiments of the invention are described above with respect to FIG. 4; however, any number of processes can be utilized, including those that disconnect content devices from display devices based on time, either alone or in conjunction with proximity data, as appropriate to the requirements of a specific application in accordance with embodiments of the invention.

### Configuring Networks

In many content display systems, many display devices and content devices are connected via a network. In order to facilitate the communication between content devices and display devices (and content display controllers), the network can be configured to allow communication between distinct groupings of display devices and content devices. For example, an authorization table can be utilized to determine and enforce access between particular display devices and content devices. Similarly, virtual networks can be created on top of the existing network that include the desired content devices and display devices. In this way, the virtual networks limit the ability of arbitrary display devices and content devices to communicate outside of the authorized pairings. The creation and authorization of networks can utilize any of a variety of data to identify the display devices, content display controllers, and/or content devices, such as by utilizing the MAC address of the devices, a unique identifier associated the devices, user profile data associated with the devices, IP (or any other network) address associated with the devices, authorized communication ports, and/or time. Additionally, directional control data for the network connection can be determined, thereby allowing one-way or two-way communication via devices on the network. For example, an authorization table can include the MAC address for a content display controller, a content device, and a listing of ports through which the devices are allowed to communicate. Additionally, user-level and/or time-based restrictions can be enforced. In this way, particular users can utilize a particular set of display devices, potentially at fixed time. Any of a variety of protocols, such as the Remote Authentication Dial-in User Service (RADIUS) protocol and the IEEE 802.1X access control protocol, can be utilized to authorize and control access between devices on the network as appropriate to the requirements of specific applications in accordance with embodiments of the invention.

A process for configuring a network in accordance with an embodiment of the invention is illustrated in FIG. 5A. The process 500 includes identifying (510) a content display controller and identifying (512) a content device. Device communication is authorized (514) and devices are connected (516).

As described above, connected devices do not stay connected forever. Disconnect data can be determined by any of a variety of devices, such as a network controller, a content device, and/or a content display controller. The disconnect data can identify one or more devices connected via the network, the time of the connection, the time of the disconnection, metadata describing the data transferred between the devices (such as, but not limited to, the amount of data transferred and/or the content of the data transferred), and/or the metadata describing the reason for the disconnection (i.e. devices no longer in range, device disconnected, etc. . . . ) as appropriate to the requirements of specific applications of embodiments of the invention. The devices can be disconnected by a variety of techniques, such as de-authorizing devices via the RADIUS protocol or IEEE 802.1X access control protocol, removing entries from an authorization table, entering data into a prohibited connection database, and/or any other technique as appropriate to the requirements of specific applications of embodiments of the invention.

A process for disconnecting devices connected to a network in accordance with an embodiment of the invention is shown in FIG. 5B. The process 550 includes determining (560) disconnect data, de-authorizing (562) device communications, and disconnecting (564) devices.

Although specific processes for configuring a network in accordance with embodiments of the invention are described above with respect to FIGS. 5A-B, any number of processes can be utilized as appropriate to the requirements of a specific application in accordance with embodiments of the invention.

### Network Security

In many content display systems, a wide variety of content devices can be utilized within the network to display content via the display devices. However, this can lead to a number of security concerns such as, but not limited to, having a single compromised content device spread malicious software to multiple display devices and/or content display controllers that could then transmit the malicious software to other content devices. A variety of techniques for preventing the spread of malicious software via the content display system can be employed. For example, security software can be installed on the content devices, content display controllers, and/or executed by the underlying network in order to identify and remove malicious software. However, this approach can introduce a significant overhead in the usability and administration of the content display system. In many embodiments, the network access between the content devices and the content display controllers can be configured to allow one-way communication between the content devices and the content display controllers, but not allow communication originating from the content display controllers and/or display devices to be transmitted to the content devices. In this way, even if a rogue content device infects one or more content display controllers with malicious software, that software cannot then be transmitted to other content devices. That is, the one-way communication can secure the content display system from transmitting malicious software to a number of content devices.

Additionally, monitoring and administration efforts can be focused on the content display controllers and/or display devices, facilitating the efficient administration of the content display network. Additionally, security software can execute on a network controller. This security software can be utilized to analyze the status of the content display controllers, identify any potential malicious software and/or incorrect configuration data, and automatically correct the identified issues. In this way, the management overhead of the content display system can be reduced by only analyzing the content display controllers rather than every device connected to the network. Additionally, the network controller can automatically apply software upgrades and/or updated configuration data to the content display controllers.

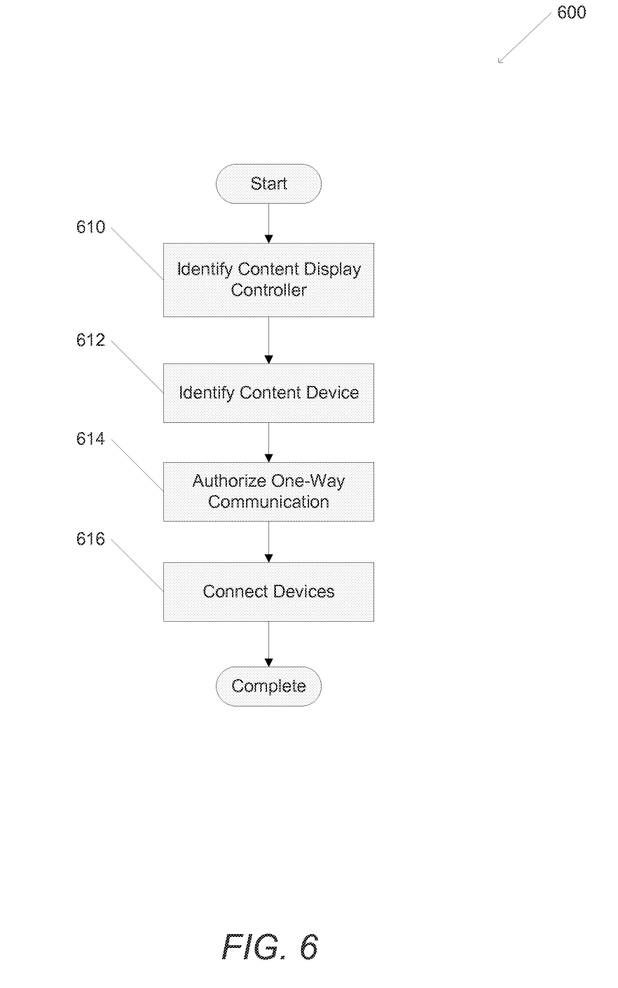

A process for securing a content display network utilizing one-way communication in accordance with an embodiment of the invention is illustrated in FIG. 6. The process 600 includes identifying (610) a content display controller and identifying (612) a content display device. One-way communication is authorized (614) and devices are connected (616).

Specific processes for implementing security measures by utilizing one-way communication across a network in accordance with embodiments of the invention are described above with respect to FIG. 6; however, any number of processes, including any other security techniques, can be utilized as appropriate to the requirements of a specific application in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A content display system, comprising:
a content display controller comprising a processor, a memory connected to the processor, a network interface connected to the processor and the memory, and a proximity sensor;
a display device connected to the content display controller; and
a content device comprising a processor, a memory connected to the processor, and a network interface connected to the processor and the memory;
wherein the content display controller:
determines when the content device is within range using the proximity sensor;
initiates a connection with the content device;
obtains data from the content device using the network interface in the content display controller; and
displays the obtained data using the display device; and
wherein the content device:
presents at least one piece of content data for display;
determines when the content device is connected to a content display controller; and
transmits the at least one piece of content data to the content display controller using the network interface in the content device.

2. The system of claim 1, wherein:
the content display system further comprises a network controller connected to the network; and
the network controller controls data transmitted via the network.

3. The system of claim 2, wherein the content display controller initiates the connection to the content device by requesting a connection with the content device from the network controller.

4. The system of claim 3, wherein the network controller:
obtains content display controller data describing the content display controller;
obtains content device data describing the content device; and
generates authorization data comprising the content display controller data and the content device data.

5. The system of claim 4, wherein:
the display controller data comprises a media access control address identifying the content display controller; and
the content device data comprises a media access control address identifying the content device.

6. The system of claim 3, wherein the network controller creates a one-way connection between the content display controller and the content device so that content provided by the content device can be transmitted to the content display controller.

7. The system of claim 2, wherein the network controller creates a virtual local area network including the content display controller and the content device.

8. The system of claim 1, wherein the proximity sensor comprises a Bluetooth Low Energy device.

9. The system of claim 1, wherein the content display controller further:
determines when the content device is no longer within range using the proximity sensor; and
initiates a disconnection from the content device.

10. The system of claim 9, wherein the content display controller further:
determines display device state data when the content device is in range, where the display device state data describes an active input of the display device;
switches the display device to a second input separate from the active input, where the second input is associated with the content display controller; and
when the content device is no longer within range, switches the display device to the active input.

11. A method for displaying content, comprising:
determining when a content device is within range using a content display controller, wherein:
the content display controller comprises a processor, a memory connected to the processor, a network interface connected to the processor and the memory, and a proximity sensor; and
the content device comprises a processor, a memory connected to the processor, and a network interface connected to the processor and the memory;
initiating a connection with the content device using the content display controller;
presenting at least one piece of content data for display using the content device;
determining when the content device is connected to a content display controller using the content device;
transmitting the at least one piece of content data to the content display controller using the network interface in the content device;
obtaining data from the content device using the network interface in the content display controller; and
displaying the obtained data using a display device connected to the content display controller.

12. The method of claim 11, wherein:
the content display system further comprises a network controller connected to the network; and
the network controller controls data transmitted via the network.

13. The method of claim 12, wherein the content display controller initiates the connection to the content device by requesting a connection with the content device from the network controller.

14. The method of claim 13, further comprising:
obtaining content display controller data describing the content display controller using the network controller;
obtaining content device data describing the content device using the network controller; and
generating authorization data comprising the content display controller data and the content device data using the network controller.

15. The method of claim 14, wherein:
the display controller data comprises a media access control address identifying the content display controller; and
the content device data comprises a media access control address identifying the content device.

16. The method of claim 13, further comprising creating a one-way connection between the content display controller and the content device so that content provided by the content device can be transmitted to the content display controller using the network controller.

17. The method of claim 12, further comprising creating a virtual local area network including the content display controller and the content device using the network controller.

18. The method of claim 11, wherein the proximity sensor comprises a Bluetooth Low Energy device.

19. The method of claim 11, further comprising:
determining when the content device is no longer within range using the content display controller; and
initiating a disconnection from the content device using the content display controller.

20. The method of claim 19, further comprising:
determining display device state data when the content device is in range using the content display controller, where the display device state data describes an active input of the display device;
switching the display device to a second input separate from the active input using the content display controller, where the second input is associated with the content display controller; and
when the content device is no longer within range, switching the display device to the active input using the content display controller.
